(19) United States
(12) Patent Application Publication
(10) Pub. No.: US 2003/0097306 A1
(43) Pub. Date: May 22, 2003

(54) Shipping system and method utilizing an application programming interface for faciltating transfer of information related to shipping of packages

(75) Inventors: Glen A. Boucher, Ansonia, CT (US); Kenneth Karbowski, Farmington, CT (US); John R. Mattioli JR., Arlington, MA (US)

Correspondence Address: Pitney Bowes Inc., Intellectual Property and Technology Law Dept., 35 Waterview Drive, P.O. Box 3000, Shelton, CT, 06484-8000, US

(73) Assignee: Pitney Bowes Incorporated, Stamford, CT

(21) Appl. No.: 09/992,255

(22) Filed: Nov. 19, 2001

(51) Int. Cl. G06F 17/60

(52) U.S. Cl. 705/26

(57) ABSTRACT

A shipping system having a server with an application programming interface that allows XML formatted data to be used with the shipping server, so as to facilitate the retrieval and presentation of shipping information to a user, is disclosed. The shipping system server is accessible to users via the Internet, wherein package rating and shipping information is obtained by one or more information request queries that can be made by the user using a client software program, such as, for example, a Web browser, and standard Internet protocol such as Hypertext Markup Language (HTTP). Responses to the queries are provided in a well defined XML format having beginning and ending tags, thereby allowing easy parsing of the information contained in the responses by the client software program for presentation to the user.

### CROSS REFERENCE TO RELATED APPLICATION(S)

Reference is made to U.S. application Ser. No. 09/411,092, filed on Oct. 4, 1999, entitled Method And System For Establishing Parcel Shipping Via The Internet, and assigned to the assignee of this application. The subject matter of the above-referenced application is hereby incorporated by reference.

### BACKGROUND OF THE INVENTION

1. Field of the Invention

The present invention relates to shipping systems and methods, and more particularly to such systems and methods that make use of the Internet.

2. Description of the Related Art

In U.S. application Ser. No. 09/411,092, a system and method for using a Web browser, such as, for example, Netscape Navigator® or Microsoft Internet Explorer®, to assist a user in shipping packages and obtain information regarding shipped packages is disclosed. The system and method disclosed help determine the best shipper to use based on various criteria, as well as allow the user to generate shipping labels and other information that may be required by a carrier in order to initiate the shipping process.

In typical shipping systems that make use of a Web based browser, it is necessary for a shipping server to process information received from the user, such as, for example, package destination, length of time for delivery, weight of the package, desired additional services, etc., and to send back information, such as, for example, rates of one or more carriers based upon the processed information, for presentation to the user via the Web browser. Such information is typically sent in hypertext markup language (HTML) or dynamic hypertext markup language (DHTML). In other situations, such as, for example, obtaining tracking information from a carrier that has been selected to ship a package, it is necessary for the shipping server to access the carrier's Web site and make tracking requests through the use of a tracking number associated with a particular package. Typically this is performed by retrieving HTML Web pages from the carrier's Web site and then stripping the received HTML information to extract particular information, such as, for example, shipping rates, optional services, the location of the package, time of arrival at a particular location, and the like. This process of parsing the received carrier's Web pages for pertinent information is known in the art as “scraping.”

There are problems, however, with scraping. For example, the shipping server must have specific knowledge of the way the result information is presented by the carrier's Web site so as to decipher the pertinent information related to the package shipment or tracking from unrelated information presented on the Web page. Thus, it is necessary to distinguish between information which is purely generic to a Web page, such as, for example, the page layout, headings, titles, advertising locations and the like, and the desired information related to the shipment or tracking of a package.

Such desired information, such as, for example, the rates for shipping a package or the location of a package at a particular time, may be provided in tabular form. If the carrier changes the presentation of the Web page, then the scraping of information by the shipping server may yield unreliable results as information may be misidentified in terms of HTML tags, location on the page, etc., all of which can give rise to unreliable parsing of the carrier's Web page.

Thus, there exists a need for a method and system for reducing the complexity of received information, determining which information is in fact the desired information, and increasing the reliability that the information obtained is in fact the desired information.

### SUMMARY OF THE INVENTION

The present invention alleviates the problems associated with the prior art and provides a method and system for reducing the complexity of received information, determining which information is in fact the desired information, and increasing the reliability that the information obtained is in fact the desired information.

According to the present invention, a shipping system server is provided with an application programming interface (API) that allows use of Extensible Markup Language (XML) formatted data to facilitate the retrieval and presentation of shipping information to a user. The shipping system server is accessible to users via the Internet, wherein package rating and shipping information is obtained by one or more information request queries that can be made by the user using a client software, such as, for example, a Web browser, and standard Internet protocol such as Hypertext Markup Language (HTTP). Responses to the queries are provided in a well defined XML format having beginning and ending tags, thereby allowing easy parsing of the information contained in the responses by the client software for presentation to the user.

Use of the API for receiving and transferring XML data to the user greatly facilitates the functionality and reliability of received information and can be utilized in the shipping system, for example, to determine shipping rates for one or more carriers, tracking information of packages, rate shopping, service availability, e-mail shipment notification, e-mail delivery confirmation, e-mail tracking progress reports and the like.

### DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 is an overall block diagram of a shipping system that utilizes XML formatted data in association with an application programming interface according to the present invention;

FIG. 2 is a process flow diagram showing a typical sequence of operations associated with use of the shipping system and method according to the present invention;

FIG. 3 is a block diagram of the architecture of the shipping server shown in FIG. 1;

FIG. 4 is a detailed block diagram of the architecture of the shipping server shown in FIG. 1;

FIG. 5 is a block diagram that illustrates the transfer of information from the client software to a shipping server that operates an API for transferring XML responses according to the present invention; and

FIG. 6 illustrates in flow chart form the process of requesting shipping information and receiving an XML response according to the present invention.

### DETAILED DESCRIPTION OF THE PRESENT INVENTION

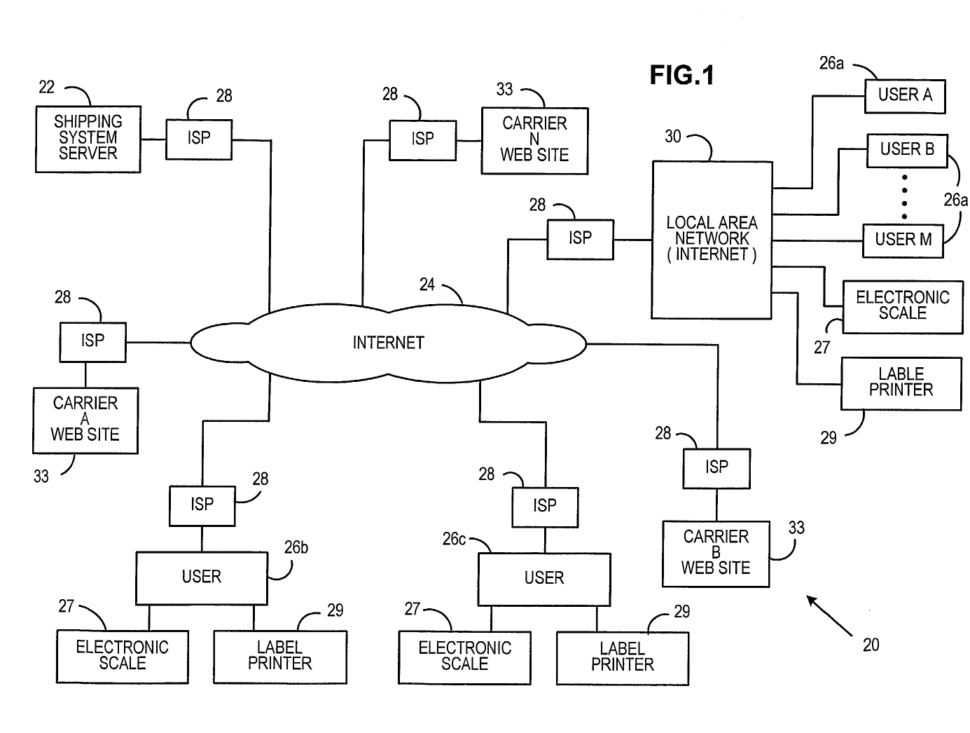

In describing the present invention, reference is made to the drawings, wherein there is seen in FIG. 1 an overall shipping system 20 that utilizes XML formatted data in association with an application programming interface according to the present invention. System 20 comprises a number of components, including a shipping system server 22 as well as one or more Web sites 33 associated with respective shipping carriers, such as, for example, Federal Express, UPS, DHL, USPS, etc. Server 22 is coupled to a network, such as, for example, the Internet 24 via an associated Internet Service Provider (ISP) 28 or any other type of Internet connection. Thus, ISP 28 may or may not be required depending upon the particular architecture and communication equipment available. Internet 24 provides interconnection of server 22 to one or more user computers 26a, 26b, 26c, as well as the carrier Web sites 33. As illustrated, some of the user computers 26a may be located at a particular enterprise and are connected to the associated ISP 28 by a local area network 30 that also connects the user computers 26a to one another.

An electronic scale 27 can be used to weigh a package and transfer this information to the shipping system server 22 via a user computer 26b-26c or LAN 30 and Internet 24. Thus, the scale may be connected to LAN 30 or directly to a user's computer 26b, 26c. Likewise a printer 29, that can print labels, can be used to print a shipping label to be attached to the package at the user's location. This arrangement avoids the need to have the shipping label prepared at an offsite location, such as a third party shipping location. The printer 29 may be directly attached to the user's computer 26b, 26c or may be connected to the LAN 30.

The shipping system 20 provides a package shipping application for use by users via a global network, typically the Internet 24, that consists of a plurality of services that are accessible by users through client software, such as, for example, a standard Web browser. Such Web browsers include, for example, the Netscape Navigator® browser, the Microsoft Internet Explorer® browser, or any other Web browser. The particular platform associated with the user's computer 26a-26c, i.e., the particular computer architecture, includes, for example, computers operating under any of the Microsoft Windows operating systems, as well as other operating systems that provide for use of a Web browser, including the Macintosh MacOS operating system or computers operating under the Unix operating system and variants thereof (such as Linux).

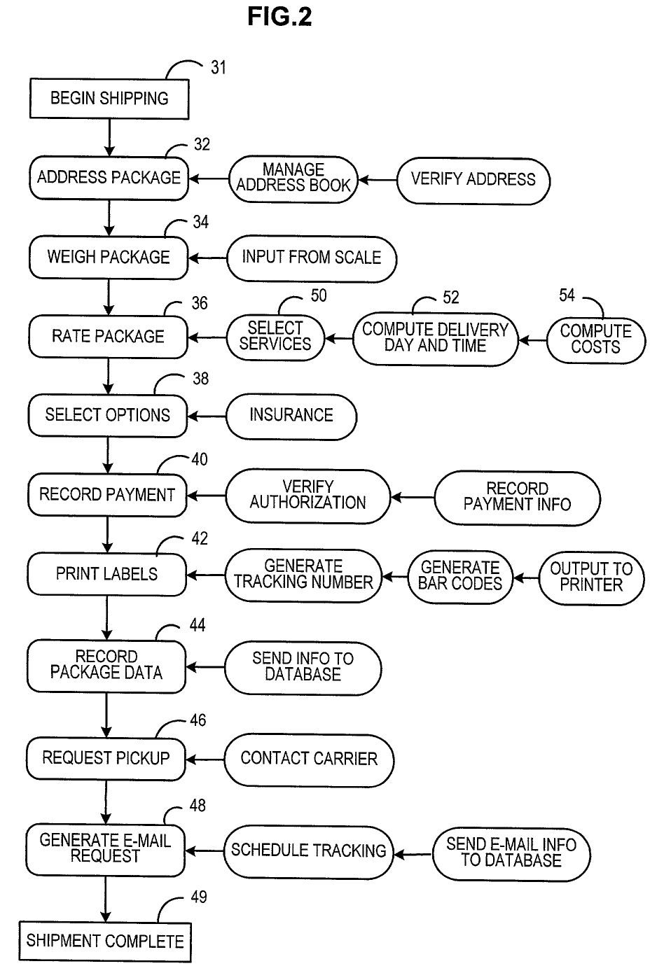

FIG. 2 illustrates the typical processing performed by shipping system 20 to allow a user to complete a shipping transaction. In step 31, a user begins the shipping process by retrieving a Web site associated with shipping system server 22 via a user computer 26a-26c, the Internet 24 and an associated client software program, such as, for example, a Web browser, running on user computer 26a-26c. The shipping system server 22 then initiates a series of steps. In step 32, an address package step is performed, wherein the user inputs a destination address for the package desired to be shipped. In step 34, a weigh package step is performed, in which the weight of the package is input either manually or directly via a scale 27. In step 36, a rate package operation is performed based on the information input in steps 32 and 34. Specifically, shipping system server 22 will access one or more carrier Web sites 33 to retrieve information relative to the parameters input in the previous steps, such as, for example, the costs of shipping the package, available services, etc. In step 38, the user is requested to select optional services for the package shipment, such as, for example, insurance for the package. In step 40, the payment is processed and recorded. In step 42, labels are printed for the package, and in step 44 data related to that package is recorded for future use. In step 46, a pick-up request is made to the selected carrier, and in step 48 an e-mail is generated notifying the recipient, as well as any other selected parties, of the package information, which results in completion of the shipping initiation process 49.

As can be seen in FIG. 2, many of these steps include various additional steps. For example, the rate package step 36 includes the additional steps of select services 50, compute delivery day and time 52, and compute costs 54. Some of the other steps process user inputs such as the select services step 50, while other steps are primarily computational, such as the compute delivery day and time step 52 and the compute costs step 54. Overall, it is seen that the steps result in an interaction between the shipping server 22 and the user so as to provide the ability for the user to select the carrier for delivery of the package to a particular destination as well as to determine various options to be associated with that shipment, including such things as managing an address book, verifying addresses, selecting optional services, recording payment information, generating a tracking number and bar codes, sending information to a database, scheduling tracking and various forms of E-mail notification. Each of these sub-steps are encapsulated into individual software components that can be arranged in ways that can customize the functionality of the overall application. Thus the particular sequence of steps shown between the begin shipping step 31 and the shipping complete step 49 can be rearranged, depending upon the needs of the particular user or on the particular implementation desired for a particular shipping system configuration. Additionally, not all steps need to be performed depending upon the particular implementation of the shipping system server 22 for a particular user.

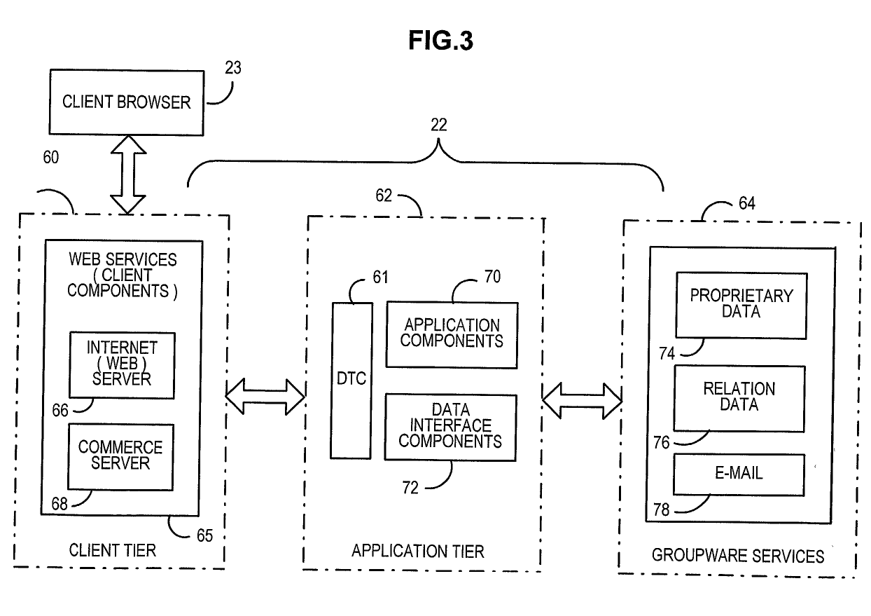

FIG. 3 illustrates in block diagram form the architecture of the shipping server 22 shown in FIG. 1. As seen in FIG. 3, the shipping system server 22 interacts (via the Internet 24) with a client software program, such as, for example, Web browser 23 (sometimes referred to as client browser), that is operating on a user computer 26a-26c in a three tier fashion; namely, the client tier 60, the application tier 62 and the groupware services tier 64. All three tiers form part of the shipper system server 22. As seen in FIG. 3, each of these major tiers includes a plurality of operational tiers and thus the client tier includes various Web services, including client components 65 that include an Internet server component 66 and a commerce server component 68. The web server component 66 is responsible for sending HTML or DHTML script to the Web browser 23 of user computer 26a-26c via Internet 24 and correspondingly to receive user inputs from the Web browser 23 of user computer 26a-26c. The commerce server 68 is responsible for handling secure transactions, such as where encryption is required. It should be understood that while FIG. 3 illustrates a Web browser 23, the invention is not so limited and any type of client software program may be utilized for interaction with the shipping system server 22.

The client tier 60 in turn communicates with the application tier 62 in which is contained the application components 70 and the data interface component 72. The distributed transaction controller 61 (DTC) is responsible for allowing multiple users to access the shipping system server 22. More particularly, the DTC 61 allows multiple users to use a single component simultaneously. The DTC 61 accomplishes this by creating multiple instances of a component to allow multiple simultaneous use of that component. If the number of users exceed the server's capabilities to create additional instances of that component, the DTC 61 provides time allocation to the users, in essence acting as an electronic traffic cop.

The application tier 62 also communicates with the groupware services tier 64 in which is contained proprietary data 74, relational data 76 and E-mail services 78. Propriety data 74 can include, for example, address information, account information, and the like, while relational data 76 includes, for example, other data which is specific to each user. The groupware services 64 is also responsible for e-mail services 78 which can generate e-mail notification to the recipient that a package is being sent to the recipient as well as e-mail notification to the user (sender) that a package has in fact been delivered. Such e-mail notifications can also be directed to third parties as requested by the user.

Thus it is readily seen that in its overall configuration, the architecture for implementing the shipping system is an N-tier architecture. The application components 70 are the software components that directly respond to user requests such as, for example, rating information, address information and the like. The data interfaces components 72 manage and schedule access to the groupware services tier 64.

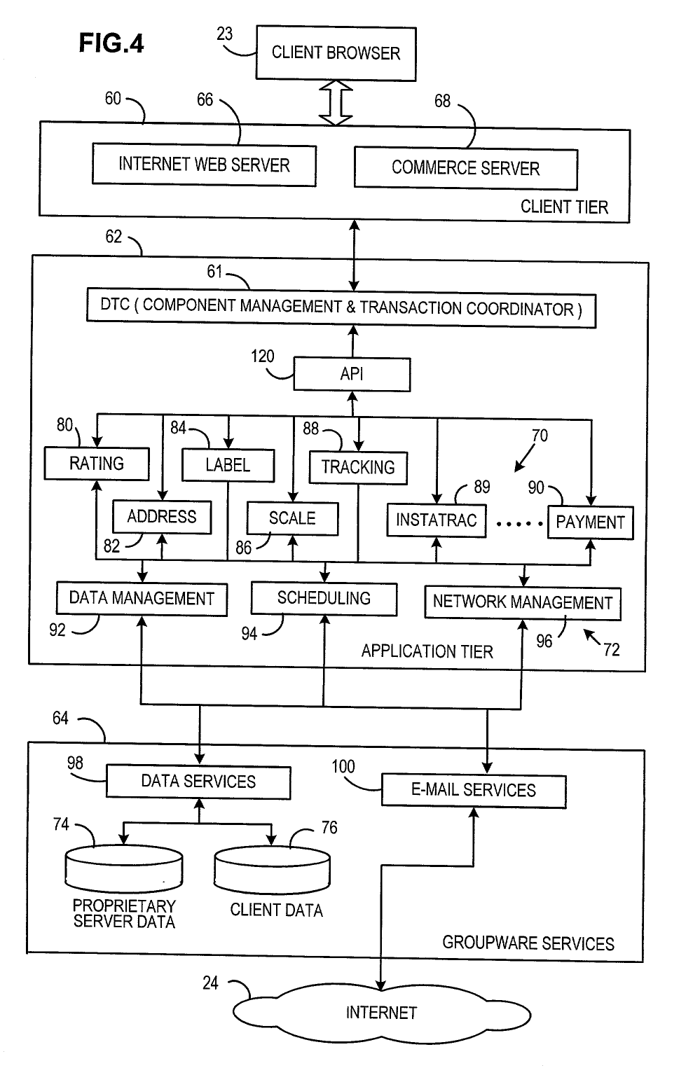

FIG. 4 illustrates in more detail the interrelationship between the browser 23 of a user computer 26a-26c with the client tier 60, the application tier 62 and the groupware services tier 64. The specific sub-tiers within these various tiers are also shown in greater detail. In particular, the application tier 62 is shown with its distributed transaction controller 61 that acts as a component manager and transaction coordinator. The DTC 61 interacts with the application components 70 and data interface components 72. The application components 70 include a rating component 80, an address component 82, a label component 84, a scale component 86, a tracking component 88, an InstaTrac component 89 and a payment component 90 as well as other components which may be added in the future. Some of these components, such as the label component 84, interact with hardware associated with the user such as the label printer 29 connected to the local area network 30 or to the user's computer 26b, 26c (see FIG. 1).

The data interface components 72 include a data management component 92, a scheduling component 94 and a network management component 96. These components in turn interface with the groupware services tier 64 which in turn includes a data services component 98, an E-mail services component 100, as well as proprietary data 74, and relational data 76 related to package information. As noted above, the proprietary data 76 includes, for example, proprietary address information which is used by the shipping server 22 to verify that the specified address of the recipient is correct. The E-mail services component 100 communicates via the Internet 24 with the recipient and/or sender and others specified by the user with respect to shipment initialization and/or delivery completion.

Thus, the N-tier configuration of the shipping system application as seen in FIG. 4, in combination with the sequence of operations as set forth in FIG. 2, provide an understanding of how the sequence of steps are performed by the shipping system server 22 in association with the browser of user computer 26a-26c and associated equipment. Further details concerning the operation of the shipping server 22 and shipping system 20 can be found in the above recited cross-referenced application.

As seen in FIGS. 3 and 4, the present shipping system 20 does not use conventional client/server methodology which requires deployment of a user or client program to user computer 26a-26c. Such a client program, typically known as a “fat” client, contains all of the presentation and business logic software needed by the user computer 26a-26c to interact with a server containing the business data. In contrast, the present invention is directed to a Web-based application in which a standard Web browser is operated on a user computer 26a-26c which in turn is operating under one of several compatible operating systems that provides for operation of the Web browser. In this configuration, the client is considered to be a “thin” client, i.e., the client (user computer 26a-26c) does not contain any presentation or business software in order to present information to the user. In operation, therefore, the shipping system application is respectively sent to the client as hypertext markup language (HTML) text or dynamic hypertext markup language (DHTML) in the application's business logic as shown in FIG. 2, executed on the shipping system server 22 (see FIG. 1).

Keeping the client end of the application as thin as possible greatly reduces the maintenance required by the customer and also improves the overall performance of the system. According to the present invention, an application programming interface (API) 120 is provided in shipping system server 22, preferably in application tier 62 as illustrated, that is utilized by a user's Web browser to access information generated by the shipping system 20. The API 120 of the present invention includes highly parameterized method calls that return a resulting string that contains the requested information or data formatted as valid Extensible Markup Language (XML). The XML format according to the present invention includes definitions and includes specific data tags as will be further described below. A user accesses the API 120 using a simple network protocol, such as, for example, Hypertext Transfer Protocol (HTTP) and receives the responses to a fixed set of functional queries in the form of XML data. The returned data, in XML format, contains the requested information in a format that is easy to parse. Thus, the API 120 according to the present invention provides users with a consistent, well-documented interface that simplifies the use of the shipping system 20.

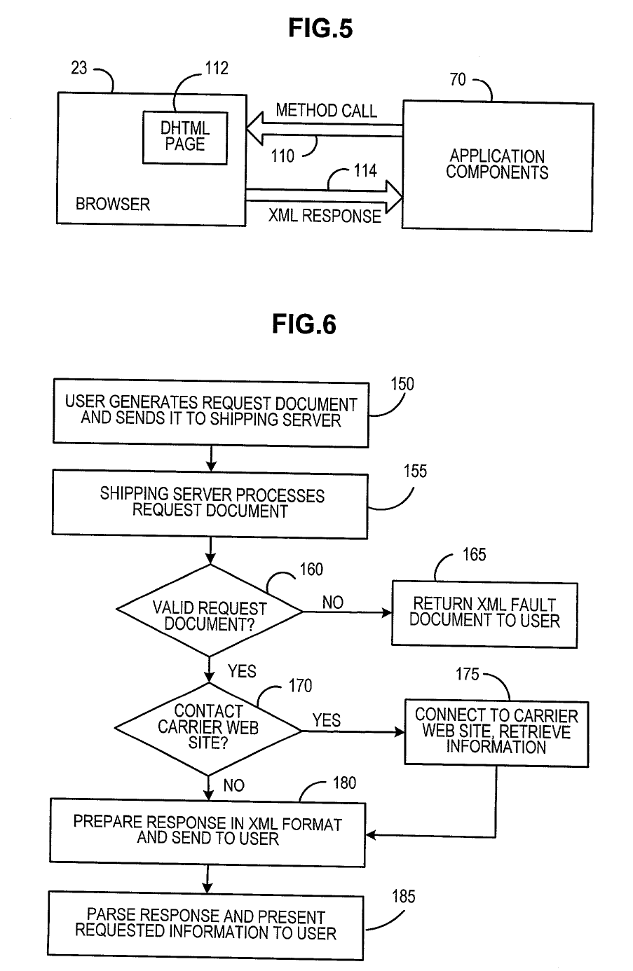

FIG. 5 illustrates in block diagram form the transfer of information from the user's Web browser to the shipping server 22 that operates an API 120 for transferring XML responses according to the present invention. The client browser 23 (operating on a user computer 26a-26c) issues a method call 110 from a generated DHTML page 112 to an application component 70 of shipping server 22. The method call 110 includes the parameters necessary for the method call 110 to be processed by the intended application component 70. For example, a method call 110 to provide shipping rates for a package would be processed by the rating component 80. The required parameters would include, for example, the destination address, weight of package, carrier name, and type of service requested. Upon receipt of the method call 110, the intended application component 70 may need to access a carrier Web site 33 to retrieve information associated with the method call 110. The information assembled by the application component 70 in response to the method call 110 is prepared in XML format and returned to the browser 23 as an XML response 114.

As noted above, the XML format used in the present invention must be completely defined and be a well-formed format that includes specific data tags. Thus, the client browser 23 will create a well-formed and validated XML instance document that conforms to a predetermined XML schema. A sample XML data format describing an exemplary list of two carriers (Federal Express and United Parcel Service) and services is given below in Table 1. Table 1 is illustrative of XML usage and shows specific data tags that may be used by shipping server 22 in association with identified shipping carriers. Additional data tags would be required to describe output data in a complete form.

TABLE 1
<PBXMLDATA>
<!--Carrier and Service List-->
<CARRIERS>

<CARRIER NAME = “Federal Express” TYPE = “Express” TOKEN = “FedEx”>

<SERVICES>

<SERVICE>

<NAME>Overnight</NAME>
<TOKEN>OVNT</TOKEN>

</SERVICE>
<SERVICE>

<NAME>2^{nd} Day Air</NAME>
<TOKEN>2DAY</TOKEN>

</SERVICE>
<SERVICE>

<NAME>First AM Express</NAME>
<TOKEN>1AM</TOKEN>

</SERVICE>

</SERVICES>

</CARRIER>
<CARRIER NAME = “United Parcel Service” TYPE = “Package” TOKEN = “UPS”>

<SERVICES>

<SERVICE>

<NAME>3 Day Select</NAME>
<TOKEN>3DAY</TOKEN>

</SERVICE>
<SERVICE>

<NAME>Ground Commercial</NAME>
<TOKEN>GCOM</TOKEN>

</SERVICE>

</SERVICES>

</CARRIER>

</CARRIERS>
<PBXMLDATA>

In Table 1 above, each item has a predefined beginning and ending tag. For example, under each carrier name is a subheading for all services offered by that carrier which begins with the tag <SERVICES>. Each such service begins with the tag <SERVICE>, provides the name of the service, such as, for example, overnight, and assigns a token to that service. The overnight service ends with the ending tag </SERVICE>. The entire list of services ends with the tag </SERVICES>. The tokens are assigned values used to uniquely identify carrier services and special services.

To request information from server 22, the user must produce a well-formed XML instance document that the server 22 can understand. The XML instance document is a document that follows the layout of a particular schema. Server 22 will respond to the user's request with either a response XML instance document, or if a fault occurs, i.e., the XML request document is not well formed according to the schema, an XML fault instance document. The response XML instance documents adhere to specified XML response schemas. Suppose, for example, a user wishes to retrieve a list of carriers supported by server 22 for shipping a package. A method call is generated at a user computer 26a-26c and passed as a request document via a DHTML page 112 to shipping system server 22. The request document will have the following form:

<?xml version=1.0”?>

<GetCarrierInformationRequest>

</GetCarrierInformationRequest>

This request will produce the following response from server 22 to the browser 23, in which the carrier identifiers (Carrier ID) are assigned character strings to distinguish carriers:

<?xml version=“1.0”?>
<GetCarrierInformationResponse>

<ListOfAvailableCarriers>

<CarrierID>AIRBORNE</CarrierID>
<CarrierID>FEDEX</CarrierID>
<CarrierID>DHL</CarrierID>
<CarrierID>UPS</CarrierID>
<CarrierID>USPS</CarrierID>

</ListOfAvailableCarriers>

</GetCarrierInformationResponse>

Because the response XML instance document adheres to the specified XML response schema, it can be easily parsed by browser 23, utilizing the beginning and ending tags for each item, and displayed to the user via user computer 26a-26c. Thus, in the above example, the beginning of the list of available carriers is signaled by the tag <ListOfAvailableCarriers> contained in the response, and the end of the list is signaled by the tag </ListOfAvailableCarriers> contained in the response. Accepting inputs and presenting the results to queries in XML format provides several efficiencies for shipping system 20. For example, the message format is flexible, i.e., XML tags can exist in the message in a variety of formats and the message composition does not have to be fixed. Additionally, messages can be extended or modified without effecting the implementation of existing users. Furthermore, many browsers have integrated parsers, thereby making the assembly and disassembly of an XML message simple without requiring any additional components. Accordingly, the system 20 according to the present invention reduces the complexity of received information, determines which information is in fact the desired information, and increases the reliability that the information obtained is in fact the desired information.

FIG. 6 illustrates in flow chart form the process of requesting shipping information and receiving an XML response according to the present invention. In step 150, the user generates a request document, utilizing browser 23 on a user computer 26a-26c, that server 22 can understand, and sends it to server 22 via Internet 24. The request document may be, for example, a request for information related to shipping rates of one or more carriers, available services, etc. As noted above, the request document must be a well-formed XML instance document that follows the layout of a particular schema that server 22 can understand. In step 155, server 22 will begin to process the request document received from the user. In step 160, server 22 determines if the request document is proper, i.e., if it is a well-formed XML instance document that follows the schema established for server 22. For example, the request document may not have all of the input parameters, such as, for example, weight of the package, destination address, type of service desired, etc. necessary for the server 22 to prepare a response. If the request document is not valid, an XML fault document will be returned to the user in step 165 and the user will have to generate a new request document.

If in step 160 it is determined that the request document is valid, then in step 170 it is determined if the server 22 needs to contact a carrier Web site 33 to process the request. For example, if the request is a tracking request, server 22 may need to connect to a carrier Web site 33, via Internet 24, to retrieve current information regarding the status of the package. If in step 170 it is determined that it is necessary to contact a carrier Web site 33, then in step 175 the server 22 will connect to the carrier Web site 33 and retrieve the information necessary to process the request from the user. Once the necessary information has been retrieved from the carrier Web site 33 in step 175, or if in step 170 it is determined that it is not necessary to contact a carrier Web site 33, then in step 180 server 22 will prepare a response document in XML format according to the pre-defined schema using starting and ending tags as previously described. The response will be sent to the Web browser 23 on user computer 26a-26c via the Internet 24.

In step 185, the response from server 22 is parsed, preferably by the browser 23 on user computer 26a-26c, and the information requested by the user in the request document is presented to the user via user computer 26a-26c. Since the response is in a well-defined format utilizing the beginning and ending tags, it can be easily parsed to determine which information is in fact the requested information, thereby increasing the reliability that the information presented to the user is in fact the desired information.

Thus, according to the present invention, an application programming interface is provided for allowing XML formatted data to be used with a shipping server, so as to facilitate the retrieval and presentation of shipping information to a user of such a shipping system. The shipping system server is accessible to users via the Internet, wherein package rating and shipping information is obtained by one or more information request queries that can be made by the user using client software, such as, for example, a Web browser, and standard internet protocol such as HTTP. Responses to the queries are provided in a well defined XML format, thereby allowing easy parsing of the information contained in the responses by the client software. The API thereby streamlines the users ability to obtain rating and shipping information via the Internet, as traditional access would require the shipping server application component to decode page content received in response to a rating query or the like in order to make use of the information.

It should be understood that although the present invention was described with respect to a shipping system, the present invention is not so limited and is applicable to any type of server in which requests for information are processed and returned. While a preferred embodiment of the invention has been described and illustrated above, it should be understood that this is exemplary of the invention and is not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A network based shipping system comprising:
at least one user computer for operation by a user desiring to ship a package to a destination, the user computer operating a client software; and
a shipping system server comprising:
a client tier adapted to interact via the network with the user computer client software to present information to the user and to receive information from the user;
an application tier adapted to provide carrier information related to shipment of said package based upon parameters associated with said shipment of said package;
a groupware services tier to maintain information concerning shipment of the package; and
an application programming interface to format at least a portion of data included in a response to an information query from said at least one user computer in a predetermined format, said predetermined format including Extensible Markup Language, and to provide said data in said predetermined format to said at least one user computer,
wherein said client software parses said data in said predetermined format for presentation to said user by said at least one user computer.

2. The network based shipping system according to claim 1, wherein said predetermined format includes predetermined data tags.

3. The network based shipping system according to claim 2, wherein said predetermined data tags includes a tag to indicate a beginning of specific data included in said response to said information query.

4. The network based shipping system according to claim 3, wherein said predetermined data tags further includes a tag to indicate an end of said specific data included in said response to said information query.

5. The network based shipping system according to claim 4, wherein said specific data includes data associated with shipping of said package to said destination.

6. The network based shipping system according to claim 5, wherein said data associated with shipping of said package includes tracking information for said package.

7. The network based shipping system according to claim 5, wherein said data associated with shipping of said package includes information related to carriers for shipping said package.

8. The network based shipping system according to claim 1, wherein said client software includes a web based browser.

9. A shipping system server comprising:
a client tier adapted to interact via a network with a client software operating on a user computer to present information to the user computer and to receive information from the user computer;
an application tier adapted to provide carrier information related to shipment of a package based upon parameters associated with said shipment of said package;
a groupware services tier to maintain information concerning said shipment of said package; and
an application programming interface to format at least a portion of data included in a response to an information query from said user computer in a predetermined format, said predetermined format including Extensible Markup Language, and to provide said data in said predetermined format to said user computer,
wherein said client software parses said data in said predetermined format for presentation to a user by said user computer.

10. The shipping system server according to claim 9, wherein said predetermined format includes predetermined data tags.

11. The shipping system server according to claim 10, wherein said predetermined data tags includes a tag to indicate a beginning of specific data included in said response to said information query.

12. The shipping system server according to claim 11, wherein said predetermined data tags further includes a tag to indicate an end of said specific data included in said response to said information query.

13. The shipping system server according to claim 12, wherein said specific data includes data associated with shipping of said package to said destination.

14. The shipping system server according to claim 13, wherein said data associated with shipping of said package includes tracking information for said package.

15. The shipping system server according to claim 13, wherein said data associated with shipping of said package includes information related to carriers for shipping said package.

16. A method for retrieving information related to shipping a package to a destination comprising the steps of:
generating a request document with a client software program on a user computer, said request document requesting said information related to shipping said package;
sending said request document to a shipping server via a network, said shipping server including a client tier adapted to interact via the network with the client software program to receive said request document and provide a response thereto, an application tier adapted to provide carrier information related to shipping said package based upon parameters associated with said shipment of said package, said parameters being included in said request document, a groupware services tier to maintain information concerning shipment of the package, and an application programming interface;
processing said request document and preparing a response to said request document;
formatting, by said application programming interface, at least a portion of data included in said response to said request document in a predetermined format, said predetermined format including Extensible Markup Language;
providing said data in said predetermined format to said user computer;
parsing, with said client software program, said data in said predetermined format to extract desired information from said response; and
presenting said desired information to a user via said user computer.

17. The method according to claim 16, wherein said predetermined format includes predetermined data tags.

18. The method according to claim 17, wherein said step of parsing further comprises:
determining a first predetermined data tag that indicates a beginning of said desired information included in said response to said request document.

19. The method according to claim 18, wherein said step of parsing further comprises:
determining a second predetermined data tag that indicates an end of said desired information in said response to said request document.

20. The method according to claim 16, wherein said desired information includes tracking information for shipping said package.

21. The method according to claim 16, wherein said desired information includes information related to carriers for shipping said package.

22. The method according to claim 16, wherein said step of processing further comprises:
determining if said request document is a valid request document.

23. The method according to claim 16, wherein said client software program includes a web based browser.
